(19) United States
(12) Patent Application Publication
(10) Pub. No.: US 2016/0275295 A1
(43) Pub. Date: Sep. 22, 2016

(54) OBJECT ENCRYPTION

(71) Applicant: EMC Corporation, Hopkinton, MA (US)

(72) Inventors: Alexey Romanovskiy, Vsevolozhsk (RU); Ilya Olegovich Borisov, Ostrov of Pskov Region (RU)

(21) Appl. No.: 14/868,687

(22) Filed: Sep. 29, 2015

(30) Foreign Application Priority Data
Mar. 19, 2015 (RU) 2015109763

(51) Int. Cl. G06F 21/60; G06F 21/62

(52) U.S. Cl. CPC G06F 21/602; G06F 21/6218

(57) ABSTRACT

A system, computer program product, and computer-executable method of managing data objects within a cloud storage provider, the system, computer program product, and computer-executable comprising receiving a data object I/O request at the cloud storage provider, parsing the data object I/O request to obtain metadata and one or more parameters, and processing the data object I/O request based on the obtained metadata and the one or more parameters, wherein the cloud storage provider is enabled to encrypt and/or decrypt a data object based on the one or more parameters.

A portion of the disclosure of this patent document may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATION

This application claims priority from Russian Application Number 2015109763 filed on Mar. 19, 2015 entitled “OBJECT ENCRYPTION” the content and teachings of which is herein incorporated by reference in its entirety.

### TECHNICAL FIELD

This invention relates to data storage.

### BACKGROUND

Computer systems are constantly improving in terms of speed, reliability, and processing capability. As is known in the art, computer systems which process and store large amounts of data typically include a one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems (MSS) typically include an array of a plurality of disks with on-board intelligent and communications electronics and software for making the data on the disks available.

Companies that sell data storage systems and the like are very concerned with providing customers with an efficient data storage solution that minimizes cost while meeting customer data storage needs. It would be beneficial for such companies to have a way for reducing the complexity of implementing data storage.

### SUMMARY

A system, computer program product, and computer-executable method of managing data objects within a cloud storage provider, the system, computer program product, and computer-executable comprising receiving a data object I/O request at the cloud storage provider, parsing the data object I/O request to obtain metadata and one or more parameters, and processing the data object I/O request based on the obtained metadata and the one or more parameters, wherein the cloud storage provider is enabled to encrypt and/or decrypt a data object based on the one or more parameters.

### BRIEF DESCRIPTION OF THE DRAWINGS

Objects, features, and advantages of embodiments disclosed herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating embodiments, principles, and concepts. Thus, features and advantages of the present disclosure will become more apparent from the following detailed description of exemplary embodiments thereof taken in conjunction with the accompanying drawings in which:

FIG. 1 is a simplified illustration of a client accessing a cloud service provider, in accordance with an embodiment of the present disclosure;

FIG. 2 is a simplified illustration of a hybrid data storage system enabled to provide data storage services through a cloud storage provider, in accordance with an embodiment of the present disclosure;

FIG. 3 is a simplified illustration of a flowchart of receiving objects in the data storage system shown in FIG. 2, in accordance with an embodiment of the present disclosure;

FIG. 4 is a simplified flowchart of a method of managing object data within the data storage system of FIG. 2, in accordance with an embodiment of the present disclosure;

FIG. 5 is a simplified flowchart of a method of retrieving data objects from a data storage shown as shown in FIG. 2, in accordance with an embodiment of the present disclosure;

FIG. 6 is a simplified flowchart of a method of retrieving a data object from a data storage system as shown in FIG. 2, in accordance with an embodiment of the present disclosure;

FIG. 7 is an example of an embodiment of an apparatus that may utilize the techniques described herein, in accordance with an embodiment of the present disclosure; and

FIG. 8 is an example of a method embodied on a computer readable storage medium that may utilize the techniques described herein, in accordance with an embodiment of the present disclosure.

Like reference symbols in the various drawings indicate like elements.

### DETAILED DESCRIPTION

Typically, cloud storage providers provide data storage for diverse purposes such as storing photos on Facebook, songs on Spotify, or files in online collaboration services, such as Dropbox. Generally, cloud storage providers are moving towards using object storage within their data storage environment in lieu of other types of file systems, such as file storage and block storage. Conventionally, object storage is a storage architecture that manages data as objects. Traditionally, object storage systems allow relatively inexpensive, scalable and self-healing retention of massive amounts of unstructured data. Generally, cloud storage providers count data storage security as an important facet of implementation of object storage. Traditionally, object storage systems may allow relatively inexpensive, scalable, and self-healing retention of massive amounts of unstructured data. Conventionally, enabling cloud storage providers to more efficiently and/or reliably encrypt objects in object storage would be beneficial to the data storage industry.

In many embodiments, the current disclosure may enable encryption of objects within a data storage system using object storage. In various embodiments, the current disclosure may enable encryption of an object as soon as the object may be received by the data storage system. In certain embodiments, the current disclosure may enable encryption of a received object before the object may be placed within object storage in a data storage system. In some embodiment, a user of a data storage system may retrieve an object in encrypted and/or decrypted form. In certain embodiments, a user of a data storage system may request decryption of an object when the object may be extracted from object storage on a data storage system. In most embodiments, upon migration of one or more data objects from a first data storage system to a data storage system, a user may be enabled to migrate the one or more data objects while maintaining the encryption of the objects. In various embodiments, migration and/or replication of an object may enable continued data protection between a first data storage system and a second data storage system.

In many embodiments, a data storage system may be a hybrid data storage solution, such as, but not limited to, EMC ViPR, OpenStack, and/or data storage system enabled to provide data storage services for a cloud storage provider. In various embodiments, the current disclosure may enable integration of data object encryption/decryption within a data storage system enabled to provide data storage services for a cloud storage provider. In certain embodiments, an integrated encryption/decryption module within a data storage system may enable elimination of separate deployment of encryption software. In other embodiments, an integrated encryption/decryption module within a data storage system may avoid separate licensing for third party encryption software. In some embodiments, an integrated encryption/decryption module within a data storage system may reduce data channel load between a client and a data storage system providing storage through a cloud storage provider. In most embodiments, an integrated encryption/decryption module within a data storage system may be enabled to efficiently use computational resources within the data storage system required for data encryption/decryption.

In many embodiments, a data storage system may receive one or more objects from one or more clients. In various embodiments, when an object is received, the object may be placed into temporary cache, encrypted, and then may be passed to the normal data channel of the data storage system pipeline. In most embodiments, when object decryption is requested, the data storage system may be enabled to return an object in either encrypted or decrypted form. In various embodiments, an encryption/decryption module within the data storage system may be enabled to encrypt and/or decrypt one or more objects transparently to the end user.

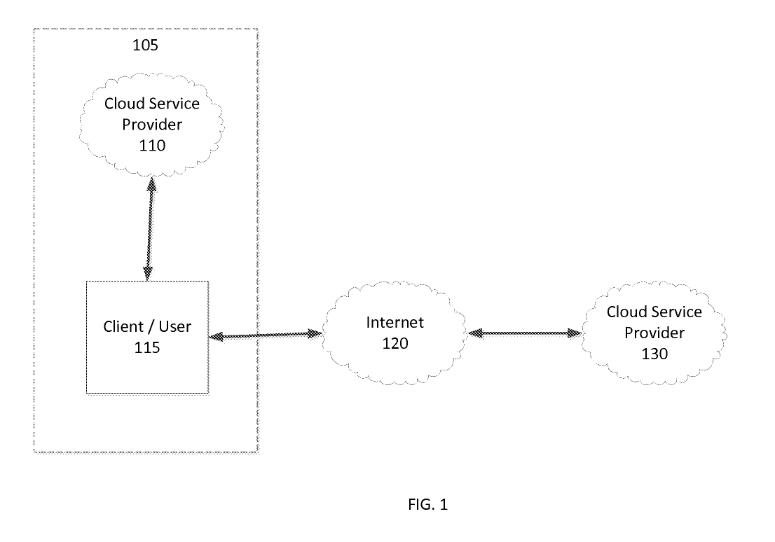

Refer to the example embodiment in FIG. 1. FIG. 1 is a simplified illustration of a client accessing a cloud service provider, in accordance with an embodiment of the present disclosure. As shown, Client/User 115 is enabled to access cloud service provider 110 and cloud service provider 130. Cloud Service Provider 110 is accessible within intranet 105. In this embodiment, cloud service provider 110 provides data storage using a hybrid data storage system enabled to encrypt and/or decrypt objects received from client/user 115. Cloud Service provider 130 is public cloud data storage providing data storage using a hybrid data storage system enabled to encrypt and/or decrypt objects received from client/user 115. In this embodiment, Client/User 115 is enabled to communicate with cloud service provider 130 through internet 120.

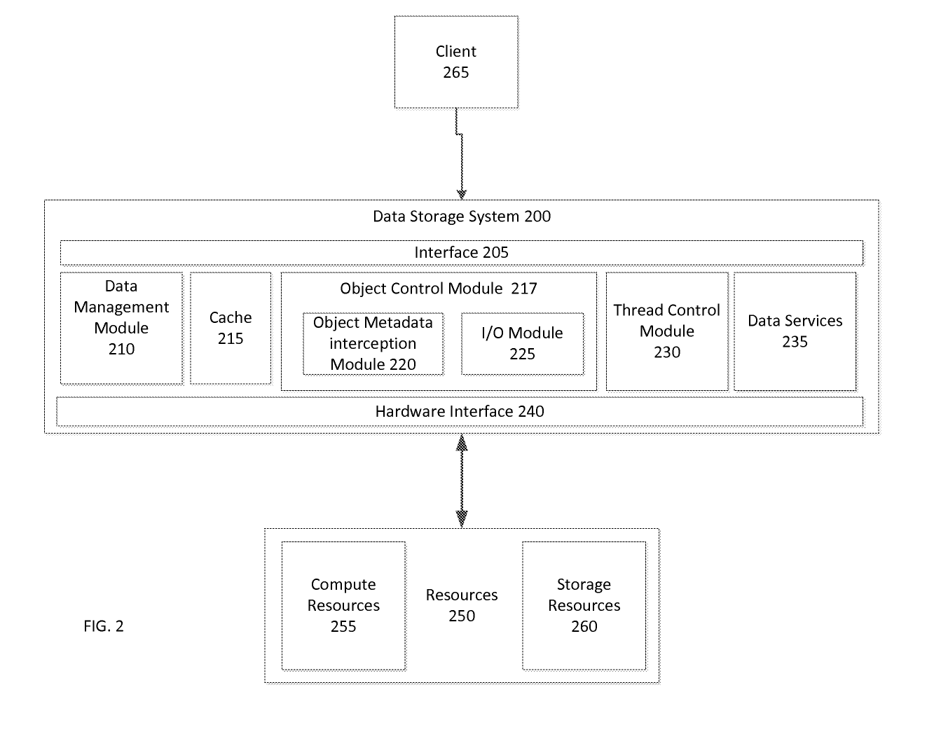

Refer to the example embodiment of FIG. 2. FIG. 2 is a simplified illustration of a hybrid data storage system enabled to provide data storage services through a cloud storage provider, in accordance with an embodiment of the present disclosure. Data storage system 200 includes interface 205, data management module 210, cache 215, object control module 217, thread control module 230, data services module 235, and hardware interface module 240. Data storage system 200 is in communication with resources 250, which includes compute resources 255 and storage resources 260. Data storage system 200 is enabled to use the hardware interface module 240 to communicate with resources 250. Resources 250 includes compute resources 255 and storage resources 260. In many embodiments, data storage resources may include hybrid data storage solutions. In various embodiments, a hybrid data storage solution may include one or more different types of data storage systems.

In this embodiment, data management module 210 is enabled to move data between the cache 215 and storage resources 260 using hardware interface 240. In many embodiments, cache may include Non-volatile memory, flash data storage, and/or other fast storage devices. Object Control Module217 includes object metadata interception module2210 and I/O module 225. As shown, data services module 235 is enabled to provide data storage services utilizing compute resources 255 and storage resources 260 from resources 250.

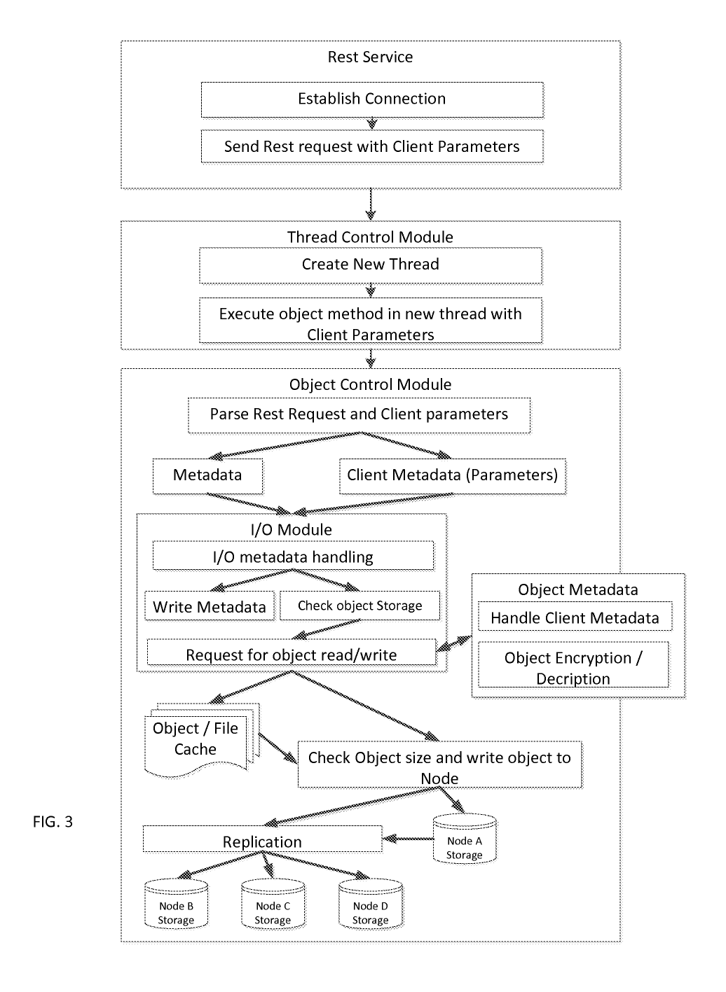

Refer to the example embodiment of FIGS. 2 and 3. FIG. 3 is a simplified illustration of a flowchart of receiving objects in the data storage system shown in FIG. 2, in accordance with an embodiment of the present disclosure. As shown, a client establishes a connection with the data storage system and sends a REST request with client parameters. The data storage system receives the REST request and the Thread Control Module creates a new thread to handle the REST request. The thread accesses the object control module which parses the REST request and Client parameters. The object control module uses the I/O module to manage the metadata, encrypt the received Object Data using the Object Metadata Intercept module, and write the encrypted Object Data to data storage. The object metadata intercept module utilizes the client metadata (parameters) to encrypt the received Object Data. In many embodiments, the presence of client metadata and/or parameters determines whether the object metadata interception module functions will be called. In various embodiments, if client metadata is present, the received object should be managed and encrypted and/or decrypted as requested. In some embodiments, client metadata may be processed and/or used by an interception module to extract encryption parameters. In various embodiments, encryption parameters may be used to encrypt and/or decrypt an object.

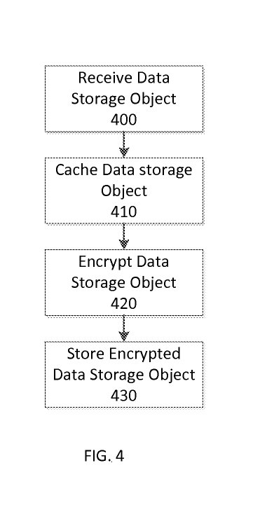

Refer to the example embodiment of FIGS. 2 and 4. FIG. 4 is a simplified flowchart of a method of managing object data within the data storage system of FIG. 2, in accordance with an embodiment of the present disclosure. Data storage system 200 includes interface 205, data management module 210, cache 215, object control module 217, thread control module 230, data services module 235, and hardware interface module 240. Data storage system 200 is in communication with resources 250, which includes compute resources 255 and storage resources 260. Data storage system 200 receives a data storage object from Client 265 using interface 205 (Step 400). Data storage system 200 utilizes data management module 210 to cache the data storage object within cache 215 (Step 410). Thread control module 230 creates a thread to manage the received data storage object temporarily stored within cache 215. The thread uses object control module 217 to encrypt the data storage object (Step 420). Upon completion of the encryption, data management module 210 moves the encrypted data storage object to storage resources 260 using hardware interface 240 (Step 430).

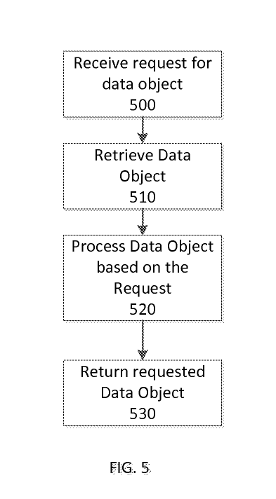

Refer to the example embodiments in FIGS. 2 and 5. FIG. 5 is a simplified flowchart of a method of retrieving data objects from a data storage shown as shown in FIG. 2, in accordance with an embodiment of the present disclosure. As shown in FIG. 2, Data storage system 200 includes interface 205, data management module 210, cache 215, object control module 217, thread control module 230, data services module 235, and hardware interface module 240. Data storage system 200 is in communication with resources 250, which includes compute resources 255 and storage resources 260. Client 265 sends a data object request to interface 205 within data storage system 200 (Step 500). Interface 205 forwards the data object request to object control module 217. Object Control module 217 utilizes data management module 210 to retrieve the requested data object from storage resources 260 (Step 510). Object Control Module 217 process retrieved data object based on the data object request (Step 520). In many embodiments, the object control module may be enabled decrypt the retrieved data object. In various embodiments, the object control module may be enabled to return the encrypted data object. Object Control module 217 utilizes interface 205 to return requested data object to client 265 (Step 530).

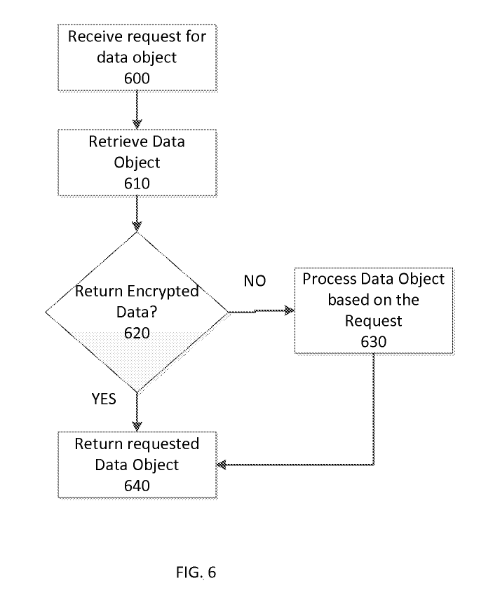

Refer to the example embodiments of FIGS. 2 and 6. FIG. 6 is a simplified flowchart of a method of retrieving a data object from a data storage system as shown in FIG. 2, in accordance with an embodiment of the present disclosure. As shown in FIG. 2, Data storage system 200 includes interface 205, data management module 210, cache 215, object control module 217, thread control module 230, data services module 235, and hardware interface module 240. Data storage system 200 is in communication with resources 250, which includes compute resources 255 and storage resources 260. Client 265 sends a data object request to interface 205 within data storage system 200 (Step 600). Interface 205 forwards data object request to object control module 217. Object control module 217 uses data management module 210 to retrieve requested data object from storage resources 260 utilizing hardware interface module 240 (Step 610). Object control module 217 analyzes the data object request to determine whether client 265 requested an encrypted data object or a decrypted data object (Step 620). If an encrypted data object was requested, object control module 217 uses interface 205 to return the retrieved encrypted data object to client 265 (Step 620). If a decrypted data object was requested, object control module 217 decrypts the encrypted data object (Step 630) and uses interface 205 to return the requested data object to client 265 (Step 640).

The methods and apparatus of this invention may take the form, at least partially, of program code (i.e., instructions) embodied in tangible non-transitory media, such as floppy diskettes, CD-ROMs, hard drives, random access or read only-memory, or any other machine-readable storage medium.

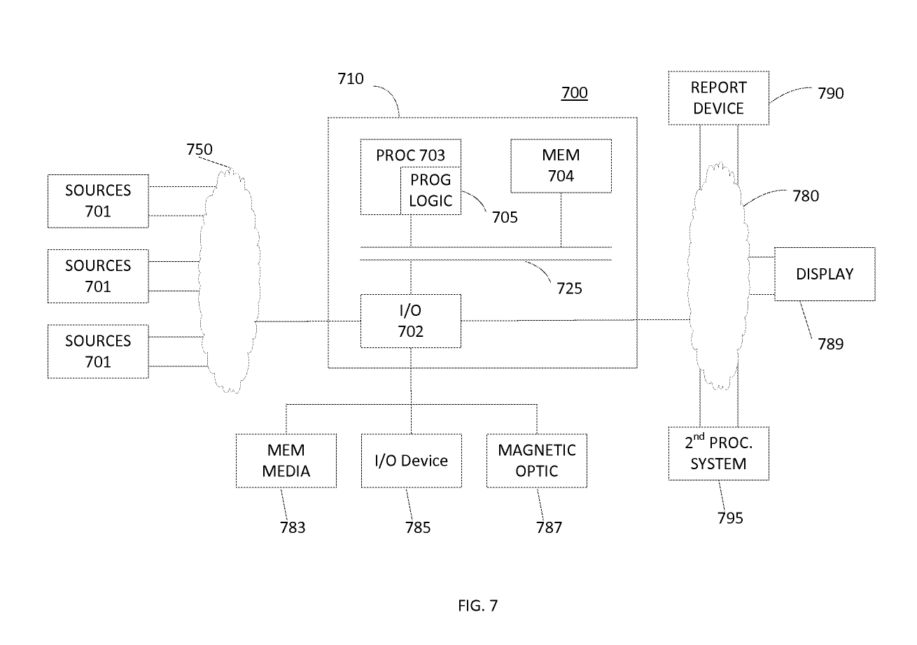

FIG. 7 is a block diagram illustrating an apparatus, such as a computer 710 in a network 700, which may utilize the techniques described herein according to an example embodiment of the present invention. The computer 710 may include one or more I/O ports 702, a processor 703, and memory 704, all of which may be connected by an interconnect 725, such as a bus. Processor 703 may include program logic 705. The I/O port 702 may provide connectivity to memory media 783, I/O devices 785, and drives 787, such as magnetic or optical drives. When the program code is loaded into memory 704 and executed by the computer 710, the machine becomes an apparatus for practicing the invention. When implemented on one or more general-purpose processors 703, the program code combines with such a processor to provide a unique apparatus that operates analogously to specific logic circuits. As such, a general purpose digital machine can be transformed into a special purpose digital machine.

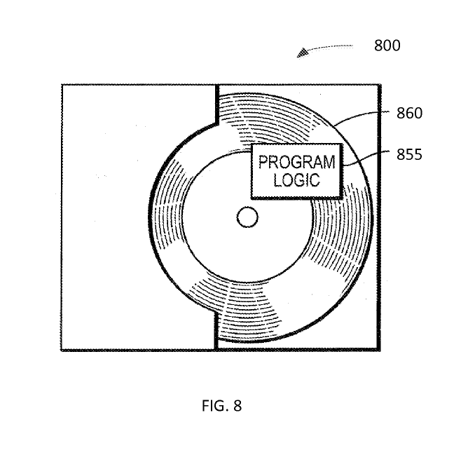

FIG. 8 is a block diagram illustrating a method embodied on a computer readable storage medium 860 that may utilize the techniques described herein according to an example embodiment of the present invention. FIG. 8 shows Program Logic 855 embodied on a computer-readable medium 860 as shown, and wherein the Logic is encoded in computer-executable code configured for carrying out the methods of this invention and thereby forming a Computer Program Product 800. Program Logic 855 may be the same logic 705 on memory 704 loaded on processor 703 in FIG. 7. The program logic may be embodied in software modules, as modules, as hardware modules, or on virtual machines.

The logic for carrying out the method may be embodied as part of the aforementioned system, which is useful for carrying out a method described with reference to embodiments shown in, for example, FIGS. 1-8. For purposes of illustrating the present invention, the invention is described as embodied in a specific configuration and using special logical arrangements, but one skilled in the art will appreciate that the device is not limited to the specific configuration but rather only by the claims included with this specification.

Although the foregoing invention has been described in some detail for purposes of clarity of understanding, it will be apparent that certain changes and modifications may be practiced within the scope of the appended claims. Accordingly, the present implementations are to be considered as illustrative and not restrictive, and the invention is not to be limited to the details given herein, but may be modified within the scope and equivalents of the appended claims.

What is claimed is:

1. A computer-executable method of managing data objects within a cloud storage provider, the computer-executable method comprising:
receiving a data object I/O request at the cloud storage provider;
parsing the data object I/O request to obtain metadata and one or more parameters; and
processing the data object I/O request based on the obtained metadata and the one or more parameters, wherein the cloud storage provider is enabled to encrypt a data object based on the one or more parameters.

2. The computer-executable method of claim 1, wherein processing comprises:
caching the data object; and
encrypting the data object based on the one or more parameters.

3. The computer-executable method of claim 2, wherein the data object I/O request is a write request; and
storing the data object within the cloud storage provider.

4. The computer-executable method of claim 1, wherein the data object I/O request is a read request;
determining whether to decrypt the requested data object based on the one or more parameters;
upon a positive determination, decrypting the requested data object; and
returning the requested data object.

5. The computer-executable method of claim 4, further comprising:
upon a negative determination, returning the requested data object, wherein the requested data object is encrypted.

6. A system, comprising:
a cloud storage provider enabled to provide data storage; and
computer-executable program logic encoded in memory of one or more computers enabled to manage data objects within the cloud storage provider, wherein the computer-executable program logic is configured for the execution of:
receiving a data object I/O request at the cloud storage provider;
parsing the data object I/O request to obtain metadata and one or more parameters; and
processing the data object I/O request based on the obtained metadata and the one or more parameters, wherein the cloud storage provider is enabled to encrypt a data object based on the one or more parameters.

7. The system of claim 6, wherein processing comprises:
caching the data object; and
encrypting the data object based on the one or more parameters.

8. The system of claim 7, wherein the computer-executable program logic is further configured for the execution of:
wherein the data object I/O request is a write request; and
storing the data object within the cloud storage provider.

9. The system of claim 6, wherein the computer-executable program logic is further configured for the execution of
wherein the data object I/O request is a read request;
determining whether to decrypt the requested data object based on the one or more parameters;
upon a positive determination, decrypting the requested data object; and
returning the requested data object.

10. The System of claim 9, wherein the computer-executable program logic is further configured for the execution of:
upon a negative determination, returning the requested data object, wherein the requested data object is encrypted.

11. A computer program product for managing data objects within a cloud storage provider, the computer program product comprising:
a non-transitory computer readable medium encoded with computer-executable code, the code configured to enable the execution of:
receiving a data object I/O request at the cloud storage provider;
parsing the data object I/O request to obtain metadata and one or more parameters; and
processing the data object I/O request based on the obtained metadata and the one or more parameters, wherein the cloud storage provider is enabled to encrypt a data object based on the one or more parameters.

12. The computer program product of claim 11, wherein processing comprises:
caching the data object; and
encrypting the data object based on the one or more parameters.

13. The computer program product of claim 12, wherein the code is further configured to enable the execution of:
wherein the data object I/O request is a write request; and
storing the data object within the cloud storage provider.

14. The computer program product of claim 11, wherein the code is further configured to enable the execution of:
wherein the data object I/O request is a read request;
determining whether to decrypt the requested data object based on the one or more parameters;
upon a positive determination, decrypting the requested data object; and
returning the requested data object.

15. The computer program product of claim 14, wherein the code is further configured to enable the execution of:
upon a negative determination, returning the requested data object, wherein the requested data object is encrypted.
